(19) United States
(12) Patent Application Publication
(10) Pub. No.: US 2026/0162609 A1
(43) Pub. Date: Jun. 11, 2026

(54) DISPLAY PANEL AND DISPLAY APPARATUS INCLUDING SAME

(71) Applicant: LG Display Co., Ltd., Seoul (KR)

(72) Inventor: Woon Hae GO, Paju-si (KR)

(73) Assignee: LG Display Co., Ltd., Seoul (KR)

(21) Appl. No.: 19/292,657

(22) Filed: Aug. 6, 2025

(30) Foreign Application Priority Data
Dec. 6, 2024 (KR) 10-2024-0180312

(51) Int. Cl. G09G 3/3233

(52) U.S. Cl. CPC G09G 3/3233; G09G 2300/0426; G09G 2300/0852; G09G 2320/0233; G09G 2330/08; G09G 2330/10

(57) ABSTRACT

A display panel capable of eliminating dark spots without repair, and a display apparatus including the same are discussed. The display panel can include a plurality of subpixels disposed at intersections of a plurality of gate lines and a plurality of data lines, first and second light-emitting elements disposed in each of the subpixels, a first pixel circuit configured to individually drive the first light-emitting element, and a second pixel circuit configured to individually drive the second light-emitting element.

### CROSS-REFERENCE TO RELATED APPLICATION

This application claims priority to Korean Patent Application No. 10-2024-0180312, filed in the Republic of Korea on Dec. 6, 2024, which is hereby expressly incorporated by reference into the present application as if fully set forth herein.

### BACKGROUND

### Field of the Disclosure

The present disclosure relates to a display apparatus, and more specifically, to a display panel capable of eliminating dark spots without repair in a display apparatus, and a display apparatus including the same.

### Discussion of the Related Art

Image display apparatuses that display various types of information on screens are core technology of the information and communication era, and are being developed into thinner, lighter, more portable, and higher performance display apparatuses. Accordingly, display apparatuses that can be manufactured in a lightweight and thin structure are in the spotlight.

Specific examples of such display apparatuses include a liquid crystal display (LCD) apparatus, a quantum dot display (QD) apparatus, a field emission display (FED) apparatus, and an organic light emitting diode (OLED) display apparatus.

An OLED display apparatus is a spontaneous emission type display apparatus and is not only advantageous in terms of power consumption due to low voltage operation, but also excellent in color expression, response speed, viewing angle, and contrast ratio (CR).

Recently, a light-emitting display apparatus has been developed in which first and second light-emitting elements connected in parallel are provided for each subpixel such that, even if one of the light-emitting elements does not emit light due to a defect, the other one emits light, thereby preventing reliability degradation caused by defective pixels.

### SUMMARY OF THE DISCLOSURE

Accordingly, the present disclosure is directed to a display panel and a display apparatus including the same that substantially obviate one or more problems due to limitations and disadvantages of the related art.

An object of the present disclosure is to provide a display panel capable of eliminating dark spots without repair in a display panel in which first and second light-emitting elements are provided for each subpixel, and a display apparatus including the same.

Additional advantages, objects, and features of the present disclosure will be set forth in part in the description which follows and in part will become apparent to those having ordinary skill in the art upon examination of the following or can be learned from practice of the present disclosure. The objectives and other advantages of the present disclosure can be realized and attained by the structure particularly pointed out in the written description and claims hereof as well as the appended drawings.

To achieve these objects and other advantages and in accordance with the purpose of the present disclosure, as embodied and broadly described herein, a display panel includes a plurality of subpixels disposed at intersections of a plurality of gate lines and a plurality of data lines, first and second light-emitting elements disposed in each of the subpixels, a first pixel circuit configured to individually drive the first light-emitting element, and a second pixel circuit configured to individually drive the second light-emitting element.

In another aspect of the present disclosure, a display apparatus includes the display panel mentioned above, a controller configured to process external input image data to suit the size and resolution of the display panel and generate a gate driving control signal and a data driving control signal using external timing signals, a gate driving circuit configured to operate according to the gate driving control signal and sequentially supply a gate signal to the plurality of gate lines of the display panel, and a data driving circuit configured to convert the image data processed by the controller in response to the data driving control signal to generate a data voltage and supply the data voltage to the plurality of data lines of the display panel in synchronization with the gate signal.

Specific details of other embodiments of the present disclosure are included in the detailed description and drawings.

It is to be understood that both the foregoing general description and the following detailed description of the present disclosure are exemplary and explanatory and are intended to provide further explanation of the present disclosure as claimed.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a block diagram showing a display apparatus according to one or more embodiments of the present disclosure;

FIG. 2 is a circuit diagram showing one subpixel circuit in the display apparatus according to an embodiment of the present disclosure;

FIG. 3 is a circuit diagram showing one subpixel circuit in a display apparatus according to another embodiment of the present disclosure; and

FIG. 4 is a diagram showing a layout of a subpixel in a display apparatus according to another embodiment of the present disclosure.

### DETAILED DESCRIPTION OF THE DISCLOSURE

Hereinafter, various embodiments of the present disclosure will be described in detail with reference to the attached drawings. Throughout the specification, the same reference numerals refer to substantially the same components.

In the following description, if a detailed description of known techniques associated with the present disclosure would unnecessarily obscure the gist of the present disclosure, detailed description thereof will be omitted. In addition, the component names used in the description below are selected for ease of specification writing and can differ from the names of parts of the actual product.

The shapes, sizes, ratios, angles, numbers, and the like, which are illustrated in the drawings in order to describe various embodiments of the present disclosure, are merely given by way of example, and therefore, the present disclosure is not limited to the illustrations in the drawings. Throughout the specification, the same reference numerals refer to substantially the same components.

In the following description, if a detailed description of known techniques associated with the present disclosure would unnecessarily obscure the gist of the present disclosure, detailed description thereof will be omitted

In the present disclosure, when the terms “comprise”, “include”, and the like are used, other elements can be added unless the term “only” is used. The singular forms are intended to include the plural forms as well, unless the context clearly indicates otherwise.

In interpretation of a component included in various embodiments of the present disclosure, the component is interpreted as including an error range unless otherwise explicitly described.

In describing various embodiments of the present disclosure, when describing a positional relationship, for example, when the positional relationship between two parts is described using “on”, “above”, “below”, “beside”, or the like, one or more other parts can be located between the two parts unless the term “directly” or “closely” is used.

In describing various embodiments of the present disclosure, when describing a temporal relationship, for example, when describing a temporal chronological relationship using the terms “after”, “following”, “next”, “before”, etc., cases that are not continuous can also be included unless “immediately” or “directly” is used.

In the description of the various embodiments of the present disclosure, although terms such as, for example, “first” and “second” can be used to describe various elements, these terms are merely used to distinguish the same or similar elements from each other. Therefore, in the present specification, an element modified by “first” can be the same as an element modified by “second” within the technical scope of the present disclosure unless otherwise mentioned. Further, the term “can” fully encompasses all the meanings and coverages of the term “may” and vice versa.

Features within the various embodiments of the present disclosure can be partially or wholly combined, and can technically operate or operate in connection, and various embodiments can be implemented independently of each other or can be implemented in combination.

Hereinafter, a display apparatus according to various embodiments of the present disclosure will be described with reference to the drawings. All the components of each display apparatus/device according to all embodiments of the present disclosure are operatively coupled and configured.

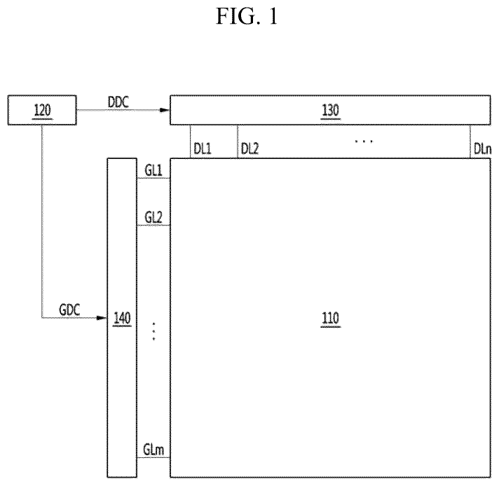

FIG. 1 is a block diagram showing a display apparatus according to one or more embodiments of the present disclosure.

As illustrated in FIG. 1, the light-emitting display apparatus according to an embodiment of the present disclosure includes a light-emitting display panel 110 including a plurality of pixels, a controller 120, a gate driving circuit 140 that supplies a gate signal to each of the plurality of pixels, a data driving circuit 130 that supplies a data signal to each of the plurality of pixels, a power supply that supplies a high-level driving voltage EVDD and a low-level driving voltage EVSS, and the like.

The display panel 110 can include an active area in which the plurality of pixels is positioned, and a non-active disposed to surround the active area. The gate driving circuit 140 or the data driving circuit 130 can be disposed in the non-active area.

The display panel 110 includes a plurality of gate lines GL1 to GLm and a plurality of data lines D1 to DLn disposed to intersect the plurality of gate lines GL1 to GLm. Each of the plurality of pixels is connected to one of the plurality of gate lines GL1 to GLm and one of the plurality of data lines DL1 to DLn. Here, m and n are real numbers such as positive integers. For example, each pixel receives a gate signal from the gate driving circuit 140 through one gate line and receives a data signal from the data driving circuit 130 through one data line. In an example, the plurality of pixels can be arranged in a matrix configuration, but can be arranged in different configurations, e.g., clusters, etc.

Here, a scan signal and an emission control signal can be supplied through the gate lines GL1 to GLm, and a data voltage Vdata can be supplied through the data lines DL1 to DLn. In addition, according to various embodiments, each gate line can include a plurality of scan lines through which a scan signal is supplied and an emission control line through which an emission control signal is supplied. In addition, the plurality of pixels can receive a reference voltage and an initialization voltage.

The display panel 110 can be implemented as a non-transparent display panel or a transparent display panel. The transparent display panel can be applied to a transparent display apparatus in which an image is displayed on a screen and an actual background is visible. The display panel 110 can be manufactured as a flexible light-emitting display panel. The flexible display panel can be implemented as an OLED display panel using a plastic substrate.

The plurality of pixels of the display panel 110 can include at least a first pixel, a second pixel, and a third pixel. The first pixel, the second pixel, and the third pixel can emit light of different colors. For example, the first pixel can be a red pixel, the second pixel can be a green pixel, and the third pixel can be a blue pixel. Each pixel can include a plurality of subpixels.

The plurality of pixels can have the same color or different colors. The sizes of the first pixel, the second pixel, and the third pixel can be designed differently in consideration of the lifespan of a light-emitting element (OLED) included in each of the first pixel, the second pixel, and the third pixel, or color balance.

Touch sensors can be disposed on the display panel 110. Touch input can be sensed using separate touch sensors or through pixels. The touch sensors can be implemented as on-cell type or add on type touch sensors disposed on the screen of the OLED display panel or as in-cell type touch sensors built into the OLED display panel 100.

The controller 120 processes image data RGB input from the outside such that the image data RGB is suitable for the size and resolution of the display panel 110 and supplies the same to the data driving circuit 130. The controller 120 generates a gate driving control signal GDC and a data driving control signal DDC using timing signals CS input from the outside, such as a dot clock signal, a data enable signal, a horizontal synchronization signal, and a vertical synchronization signal. By supplying the generated gate driving control signal GDC and data driving control signal DDC to the gate driving circuit 140 and the data driving circuit 130, the controller 200 controls the gate driving circuit 140 and the data driving circuit 130.

The controller 120 can be configured to be combined with various processors, such as a microprocessor, a mobile processor, and an application processor depending on the device to be mounted in the display apparatus.

A host system can be any one of a TV system, a set-top box, a navigation system, a personal computer (PC), a home theater system, a mobile device, a wearable device, and a vehicle system.

The controller 120 can multiply an input frame frequency by i and control the operation timing of an OLED display panel driver at a frame frequency of input frame frequency×i (i being a positive integer greater than 0) Hz. The input frame frequency can be 60 Hz in the case of NTSC (National Television Standards Committee) and 50 Hz in the case of PAL (Phase-Alternating Line).

The controller 120 generates signals such that the pixels can be driven at various refresh rates. That is, the controller 120 can generate signals related to driving such that the pixels can be driven in a variable refresh rate (VRR) mode or can switch between a first refresh rate and a second refresh rate. For example, the controller 120 can drive the pixels at various refresh rates by simply changing the rate of the clock signal, generating synchronization signals such that a horizontal blank or a vertical blank is created, or driving the gate driving circuit 140 in a mask manner.

The data driving circuit 130 receives image data DATA and the data driving control signal DDC from the controller 120. In response to the data driving control signal DDC from the controller 120, the data driving circuit 130 converts the image data DATA into a gamma compensation voltage to generate a data voltage Vdata, and supplies the data voltage Vdata to the data lines DL1 to DLn of the display panel 110 in synchronization with a scan signal. The data driving circuit 130 can be connected to the data lines of the display panel 110 by a COG (Chip On Glass) process or a TAB (Tape Automated Bonding) process.

The gate driving circuit 140 operates according to the gate driving control signal GDC to generate a gate signal. Then, the gate driving circuit 140 sequentially supplies the gate signal to the gate lines GL1 to GLm. The gate driving circuit 140 can be formed directly on the lower substrate of the display panel 110 in a GIP (Gate driver In Panel) structure. The gate driving circuit 140 can be formed in an active area in which a screen is displayed on the display panel 110, or can be formed in a non-active area outside the active area. The non-active area can include a bezel area, or can be the same as the bezel area.

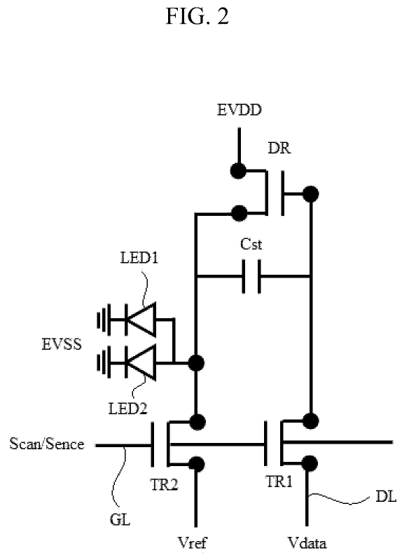

FIG. 2 is a circuit diagram showing one subpixel circuit in the display apparatus according to an embodiment of the present disclosure. As an example, each subpixel of each pixel of the display apparatus can include the configuration of FIG. 2.

Referring to FIG. 2, in order to prevent reliability degradation due to defective pixels, the subpixel according to an embodiment of the present disclosure can include first and second light-emitting elements LED1 and LED2 connected in parallel. As an example, the first and second light-emitting elements LED1 and LED2 can be light emitting diodes, but other examples are possible.

For example, the subpixel according to an embodiment of the present disclosure can include a switching transistor TR1, a sensing transistor TR2, a driving transistor DR, the first and second light-emitting elements LED1 and LED2, and a storage capacitor Cst.

The first and second light-emitting elements LED1 and LED2 can be connected in parallel and operate to emit light according to a driving current generated by the driving transistor DR. Each of the first and second light-emitting elements LED1 and LED2 can include an anode, a cathode, and an emission layer interposed between the anode and the cathode.

The switching transistor TR1 can perform a switching operation in response to a scan signal Scan supplied through a gate line GL such that a data voltage Vdata supplied through a data line DL is stored in the storage capacitor Cst. The storage capacitor Cst can maintain the data voltage for one frame.

The driving transistor DR can operate in response to the data voltage stored in the storage capacitor Cst such that a constant driving current flows between a high-level power line EVDD and a low-level power line EVSS.

The sensing transistor TR2 can operate to sense the threshold voltage of the driving transistor DR.

The transistors constituting each subpixel can be implemented as oxide thin film transistors including an oxide semiconductor layer. The oxide thin film transistor is advantageous for a large-area display panel 110 when considering electron mobility, process deviation, etc. The present disclosure is not limited thereto, and semiconductor layers of the transistors can be formed of amorphous silicon or polysilicon.

Each subpixel can be divided into a red subpixel, a green subpixel, and a blue subpixel for color implementation. Each subpixel can further include a white subpixel.

In the display apparatus according to an embodiment of the present disclosure configured as above, the first and second light-emitting elements LED1 and LED2 connected in parallel are provided for each subpixel, and thus even if one of the first and second light-emitting elements LED1 and LED2 does not emit light due to a defect, the other one can emit light. Therefore, reliability degradation due to defective pixels can be prevented. In addition, since the reliability is improved, increase in the manufacturing cost and manufacturing time due to a repair process can be prevented.

However, in the case of a top emission type display panel, there is a possibility of a short-circuit occurring between the anode and the cathode of a light-emitting element because a transparent electrode is used as the cathode.

If a short-circuit occurs between the anode and cathode in one of the first and second light-emitting elements LED1 and LED2 connected in parallel, both the first and second light-emitting elements LED1 and LED2 may not emit light. For example, the driving current is passed by the light-emitting element whose anode and cathode are short-circuited, and thus the driving current is not supplied to the other light-emitting element. Therefore, neither of the first and second light-emitting elements LED1 and LED2 emits light.

In addition, even if a repair process of cutting the path of the driving current supplied to the light-emitting element whose anode and cathode are short-circuited between the first and second light-emitting elements LED1 and LED2 is successfully performed, semi-darkening occurs, and if the repair process fails, darkening occurs.

In order to solve such a limitation, a display apparatus according to another embodiment of the present disclosure can have subpixels each including first and second light-emitting elements LED1 and LED2, and can drive the first and second light-emitting elements LED1 and LED2 separately.

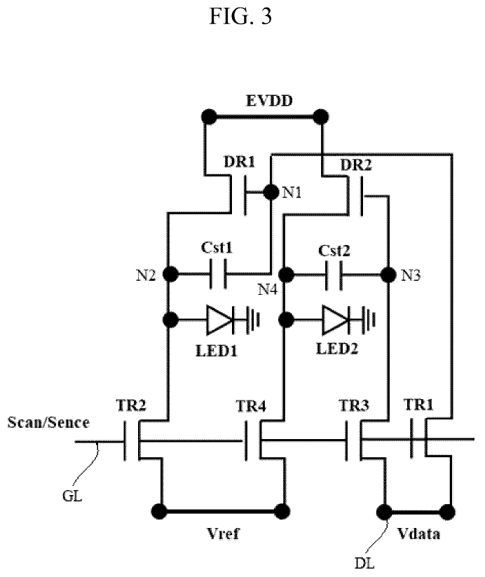

FIG. 3 is a circuit diagram showing one subpixel circuit in the display apparatus according to another embodiment of the present disclosure. As an example, each subpixel of each pixel of the display apparatus can include the configuration of FIG. 3.

As shown in FIG. 3, a subpixel (e.g., each subpixel) of the display apparatus according to another embodiment of the present disclosure can include first and second light-emitting elements LED1 and LED2 that operate individually, a first pixel circuit DR1, TR1, TR2, and Cst1 that individually drives the first light-emitting element LED1, and a second pixel circuit DR2, TR3, TR4, and Cst2 that individually drives the second light-emitting element LED2. As an example, the first and second light-emitting elements LED1 and LED2 can be light emitting diodes, but other examples are possible.

The first light-emitting element LED1 can operate to emit light according to a driving current generated by the first driving transistor DR1. The second light-emitting element LED2 can operate to emit light according to a driving current generated by the second driving transistor DR2.

Each of the first and second light-emitting elements LED1 and LED2 can include an anode, a cathode, and an emission layer interposed between the anode and the cathode.

The first switching transistor TR1 can perform a switching operation in response to a scan signal Scan supplied through a gate line GL such that a data voltage Vdata supplied through a data line DL is stored in the first storage capacitor Crt1. The second switching transistor TR3 can perform a switching operation in response to the scan signal Scan supplied through the gate line GL such that the data voltage Vdata supplied through the data line DL is stored in the second storage capacitor Cst2.

The first and second storage capacitors Cst1 and Cst2 can maintain the data voltage for one frame.

The first driving transistor DR1 can operate to allow a constant driving current to flow between the high-level power line EVDD and the low-level power line EVSS in response to the data voltage stored in the first storage capacitor Cst1. Therefore, the first driving transistor DR1 can provide the driving current to the first light-emitting element LED1.

The second driving transistor DR2 can operate to allow a constant driving current to flow between the high-level power line EVDD and the low-level power line EVSS in response to the data voltage stored in the second storage capacitor Cst2. Therefore, the second driving transistor DR2 can provide the driving current to the second light-emitting element LED2.

The first sensing transistor TR2 can operate to sense the threshold voltage of the first driving transistor DR1. For example, the first sensing transistor TR2 can operate to sense the threshold voltage of the first driving transistor DR1 in response to the sensing signal Sense supplied through the gate line GL.

The second sensing transistor TR4 can operate to sense the threshold voltage of the second driving transistor DR2. For example, the second sensing transistor TR4 can operate to sense the threshold voltage of the second driving transistor DR2 in response to the sensing signal Sense supplied through the gate line GL.

This will be described in more detail below.

The first driving transistor DR1 has a gate electrode electrically connected to a first node N1, a first electrode electrically connected to the high-level power line EVDD, and a second electrode electrically connected to a second node N2.

The first storage capacitor Cst1 is electrically connected between the first node N1 and the second node N2. The first light-emitting element LED1 is electrically connected between the second node N2 and the low-voltage power line (ground line) EVSS. The first switching transistor TR1 has a gate electrode electrically connected to the gate line GL, a first electrode electrically connected to the data line DL, and a second electrode electrically connected to the first node N1.

The first sensing transistor TR2 has a gate electrode electrically connected to the gate line GL, a first electrode electrically connected to a reference voltage line Vref, and a second electrode electrically connected to the second node N2.

The second driving transistor DR2 has a gate electrode electrically connected to a third node N3, a first electrode electrically connected to the high-level power line EVDD, and a second electrode electrically connected to a fourth node N4.

The second storage capacitor Cst2 is electrically connected between the third node N3 and the fourth node N4.

The second light-emitting element LED2 is electrically connected between the fourth node N4 and the low-level power line (ground line) EVSS.

The second switching transistor TR3 has a gate electrode electrically connected to the gate line GL, a first electrode electrically connected to the data line DL, and a second electrode electrically connected to the third node N3.

The second sensing transistor TR4 has a gate electrode electrically connected to the gate line GL, a first electrode electrically connected to the reference voltage line Vref, and a second electrode electrically connected to the fourth node N4.

The layout of the subpixel of the display apparatus according to another embodiment of the present disclosure configured in this manner will be described below.

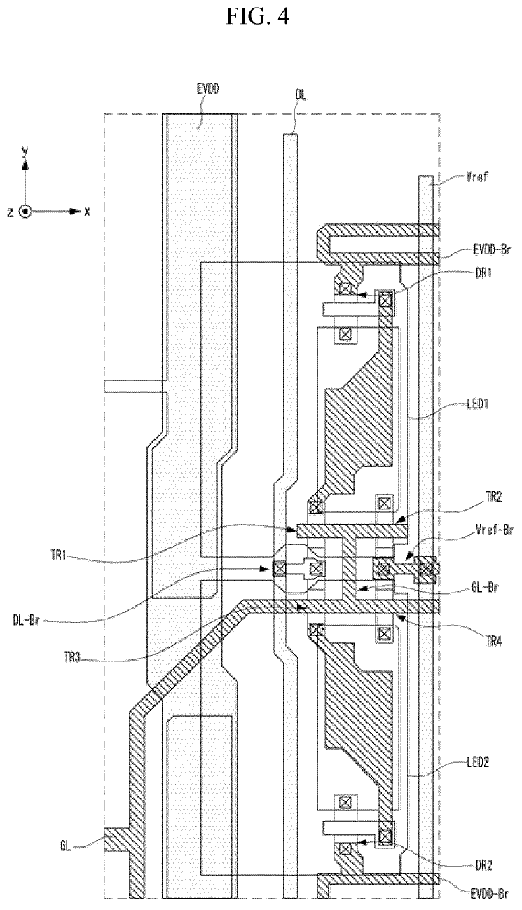

FIG. 4 is a diagram showing the layout of the subpixel of the display apparatus according to another embodiment of the present disclosure.

As illustrated in FIG. 4, the high-level power line EVDD, the data line DL, and the reference voltage line Vref are disposed in parallel. For example, the high-level power line EVDD, the data line DL, and the reference voltage line Vref can be disposed in the Y-axis direction.

The gate line GL is disposed in a direction perpendicular to the high-level power line EVDD, the data line DL, and the reference voltage line Vref. For example, the gate line GL can be disposed in the X-axis direction.

The first and second light-emitting elements LED1 and LED2 can be disposed on the upper and lower sides of a center line of the subpixel.

The first switching transistor TR1 and the second switching transistor TR3 can be disposed in parallel in the vertical direction with respect to the center line of the subpixel, and the first sensing transistor TR2 and the second sensing transistor TR4 can also be disposed in parallel in the vertical direction.

The first and second driving transistors DR1 and DR2 can be disposed on the upper and lower sides of the center line of the subpixel.

The reference voltage line Vref can be electrically connected to the first electrodes of the first sensing transistor TR2 and the second sensing transistor TR4 through a reference voltage bridge line Vref-Br.

The data line DL can be electrically connected to the first electrodes of the first switching transistor TR1 and the second switching transistor TR3 through a data bridge line DL-Br.

The gate line GL can be electrically connected to the gate electrodes of the first switching transistor TR1, the second switching transistor TR3, the first sensing transistor TR2, and the second sensing transistor TR4 through a gate bridge line GL-Br.

The high-level power line EVDD can be electrically connected to the first electrodes of the first and second driving transistors DR1 and DR2 through a high-level power bridge line EVDD-Br.

The second electrode of the first switching transistor TR1 can be electrically connected to the gate electrode of the first driving transistor DR1, and the second electrode of the second switching transistor TR3 can be electrically connected to the gate electrode of the second driving transistor DR2.

The second electrode of the first driving transistor DR1 and the second electrode of the first sensing transistor TR2 can be formed integrally, and the second electrode of the second driving transistor DR2 and the second electrode of the second sensing transistor TR4 can be formed integrally.

The second electrode of the first switching transistor TR1 and the integrally formed second electrodes of the first driving transistor DR1 and the first sensing transistor TR2 can overlap each other to form the first storage capacitor Cst1, and the second electrode of the second switching transistor TR3 and the integrally formed second electrodes of the second driving transistor DR2 and the second sensing transistor TR4 can overlap each other to form the second storage capacitor Cst2.

The first light-emitting element LED1 can be electrically connected to the integrally formed second electrodes of the first driving transistor DR1 and the first sensing transistor TR2, and the second light-emitting element LED2 can be electrically connected to the integrally formed second electrodes of the second driving transistor DR2 and the second sensing transistor TR4.

For example, the anode of the first light-emitting element LED1 can be electrically connected to the integrally formed second electrodes of the first driving transistor DR1 and the first sensing transistor TR2, and the cathode of the first light-emitting element LED1 can be electrically connected to the low-level power line (refer to the ground terminal of FIG. 3).

The anode of the second light-emitting element LED2 can be electrically connected to the integrally formed second electrodes of the second driving transistor DR2 and the second sensing transistor TR4, and the cathode of the second light-emitting element LED2 can be electrically connected to the low-level power line (refer to the ground terminal of FIG. 3).

As described above, the display panel according to another embodiment of the present disclosure can eliminate dark spots without a separate repair process since the first and second light-emitting elements LED1 and LED2 are disposed in each subpixel and the first light-emitting element LED1 and the second light-emitting element LED2 are driven by different pixel circuits.

According to aspects of the present disclosure, first and second light-emitting elements are provided in each subpixel, and the first light-emitting element and the second light-emitting element are driven by different pixel circuits. Therefore, even if a short-circuit occurs between the anode and the cathode in one of the first and second light-emitting elements, the other light-emitting element operates, and thus dark spots can be eliminated without a separate repair process.

It will be apparent to those skilled in the art that various modifications and variations can be made in the present disclosure without departing from the spirit or scope of the present disclosure. Thus, it is intended that the present disclosure cover the modifications and variations of the present disclosure provided they come within the scope of the appended claims and their equivalents.

What is claimed is:

1. A display panel comprising:
a plurality of subpixels disposed at intersections of a plurality of gate lines and a plurality of data lines;
a first light-emitting element and a second light-emitting element disposed in a subpixel among the plurality of subpixels;
a first pixel circuit configured to individually drive the first light-emitting element; and
a second pixel circuit configured to individually drive the second light-emitting element.

2. The display panel of claim 1, wherein the first pixel circuit comprises:
a first switching transistor configured to store a data voltage in a first storage capacitor in response to a scan signal; and
a first driving transistor configured to supply a driving current to the first light-emitting element in response to the data voltage stored in the first storage capacitor.

3. The display panel of claim 2, wherein the second pixel circuit comprises:
a second switching transistor configured to store a data voltage in a second storage capacitor in response to the scan signal; and
a second driving transistor configured to supply a driving current to the second light-emitting element in response to the data voltage stored in the second storage capacitor.

4. The display panel of claim 3, wherein the first and second light-emitting elements are respectively disposed on upper and lower sides with respect to a center line of the subpixel.

5. The display panel of claim 3, wherein:
the first pixel circuit further comprises a first sensing transistor configured to operate to sense a threshold voltage of the first driving transistor in response to a sensing signal, and
the second pixel circuit further comprises a second sensing transistor configured to operate to sense a threshold voltage of the second driving transistor in response to the sensing signal.

6. The display panel of claim 5, wherein the first switching transistor and the second switching transistor are disposed in parallel in a vertical direction with respect to the center line of the subpixel,
wherein the first sensing transistor and the second sensing transistor are disposed in parallel in the vertical direction with respect to the center line of the subpixel, and
wherein the first driving transistor and the second driving transistor are disposed on upper and lower sides with respect to the center line of the subpixel.

7. The display panel of claim 5, wherein the first switching transistor and the first sensing transistor are arranged side by side in a horizontal direction,
the second switching transistor and the second sensing transistor are arranged side by side in the horizontal direction, and
a gate bridge line branched from a gate line extending in the horizontal direction extends between the first switching transistor and the first sensing transistor and between the second switching transistor and the second sensing transistor, to be electrically connected to gate electrodes of the first switching transistor, the second switching transistor, the first sensing transistor, and the second sensing transistor.

8. The display panel of claim 5, wherein the first switching transistor, the second switching transistor, the first sensing transistor, and the second sensing transistor are disposed between the first light-emitting element and the second light-emitting element.

9. The display panel of claim 5, further comprising:
a reference voltage line disposed parallel to the plurality of data lines and electrically connected to first electrodes of the first sensing transistor and the second sensing transistor through a reference voltage bridge line; and
a high-level power line disposed parallel to the plurality of data lines and electrically connected to gate electrodes of the first driving transistor and the second driving transistor through a high-level power bridge line.

10. The display panel of claim 9, wherein one of the plurality of data lines is electrically connected to first electrodes of the first switching transistor and the second switching transistor through a data bridge line, and
wherein the plurality of gate lines are disposed perpendicular to the plurality of data lines, and one of the plurality of gate lines is electrically connected to gate electrodes of the first switching transistor, the second switching transistor, the first sensing transistor, and the second sensing transistor through a gate bridge line.

11. The display panel of claim 10, wherein a second electrode of the first switching transistor is electrically connected to the gate electrode of the first driving transistor, and a second electrode of the second switching transistor is electrically connected to the gate electrode of the second driving transistor.

12. The display panel of claim 11, wherein a second electrode of the first driving transistor and the second electrode of the first sensing transistor are formed integrally, and a second electrode of the second driving transistor and the second electrode of the second sensing transistor are formed integrally.

13. The display panel of claim 12, wherein the first storage capacitor is configured by overlapping the second electrode of the first switching transistor and the integrally formed second electrodes of the first driving transistor and the first sensing transistor, and
wherein the second storage capacitor is configured by overlapping the second electrode of the second switching transistor and the integrally formed second electrode of the second driving transistor and the second sensing transistor.

14. The display panel of claim 12, wherein the first light-emitting element is electrically connected to the integrally formed second electrode of the first driving transistor and the first sensing transistor, and
wherein the second light-emitting element is electrically connected to the integrally formed second electrode of the second driving transistor and the second sensing transistor.

15. The display panel of claim 1, further comprising:
a first storage capacitor connected to one end of the first light-emitting element; and
a second storage capacitor connected to one end of the second light-emitting element.

16. The display panel of claim 1, wherein the plurality of subpixels are disposed at intersections of a plurality of gate lines and a plurality of data lines, and
wherein the first pixel circuit and the second pixel circuit share the same one date line and the same one gate line.

17. A display apparatus comprising:
the display panel according to claim 1;
a controller configured to process external input image data to suit a size and resolution of the display panel and generate a gate driving control signal and a data driving control signal using external timing signals;
a gate driving circuit configured to operate according to the gate driving control signal and sequentially supply a gate signal to the plurality of gate lines of the display panel; and
a data driving circuit configured to convert the image data processed by the controller in response to the data driving control signal to generate a data voltage and supply the data voltage to the plurality of data lines of the display panel in synchronization with the gate signal.

18. A subpixel, comprising:
first and second light-emitting elements;
a first driving transistor having a first electrode connected to the first light-emitting element, and a second electrode;
a second driving transistor having a first electrode connected to the second light-emitting element, and a second electrode connected to the second electrode of the first driving transistor;
a first switching transistor having a first electrode connected to a gate electrode of the first driving transistor; and
a second switching transistor having a first electrode connected to a gate electrode of the second driving transistor,
wherein a second electrode of the first switching transistor is connected to a second electrode of the second switching transistor, and
wherein a gate electrode of the first switching transistor is connected to a gate electrode of the second switching transistor.
